(19) United States
(12) Patent Application Publication
(10) Pub. No.: US 2005/0039394 A1
(43) Pub. Date: Feb. 24, 2005

(54) Plant support device

(76) Inventor: Frederick J. Kelly, Elmira, NY (US)

Correspondence Address: Frank A. LaViola, Jr.;Cameron Fabricating Corporation, PO Box 478, Horseheads, NY, 14845, US

(21) Appl. No.: 10/643,337

(22) Filed: Aug. 19, 2003

(51) Int. Cl. A01G 9/12; A01G 17/04

(52) U.S. Cl. 47/45

(57) ABSTRACT

A plant support device that is tip over resistant for vertical support of tomato and other climbing plants that allows for space conservation, maximum sunlight absorption and easy access to cleaner fruit. The easily assembled and disassembled unit comprises vertical uprights, a plurality of hoops and clamping mechanisms assembled to meet the needs of plant growth. The unit may also have a knob and hole arrangement for aiding in securing the hoops to the uprights. The unit may be made of a variety of materials and the individual pieces can be of unitary construction or of a construction that allows for maximum flexibility of size and shape. The hoops and uprights may be made of smaller, interconnected pieces, which provide for increasing or decreasing the dimensions and spacings to better meet the needs of the plant to be supported.

### BACKGROUND OF THE INVENTION

1. Field of the Invention

This invention is a support assembly for growing fruit and non-fruit bearing plants which require support to maximize growth and fruit production. Maximum absorption of sunlight, space conservation and easy harvesting of clean fruit during the growing season are key advantages of the present invention. Another major advantage of the present invention is adjustability of the support assembly for plants of varying heights while also allowing for adjustment during the growth of the plant. A further advantage of the present invention is the ability to disassemble the device and store it compactly and conveniently until the next growing season.

Traditional support mechanisms range from wooden stakes to support cages made from concrete reinforcement wire. There are many disadvantages with these traditional support mechanisms. First, wooden stakes are subject to rot and tip over quite readily. They also can be carriers of disease. Wood stakes require the grower to drive the stake into the ground sufficiently to hold the plant and its fruit. After that is done, the grower must devise a way to fasten the growing plant to the stake. Concrete reinforcement cages are hard to work with, offers no degree of adjustability, are subject to rust and are bulky for winter storage. They are traditionally welded in a solid construction and thus cannot be disassembled for storage.

2. Description of the Prior Art

Many patents exist with regard to the support of plants during their growth. U.S. Pat. No. 5,640,802 discloses a stackable assembly for plant support. U.S. Pat. No. 6,088,956 discloses a foldable structure for plant support. U.S. Pat. No. 5,179,799 discloses a demountable plant support structure. U.S. Pat. No. 6,385,901 discloses a three-panel support cage. U.S. Pat. No. 5,174,060 discloses a plant support with a rigidly attached, helically coiled support member. The above listed five structures limit the grower to setting up the support system according to expected growth of a particular determinate or indeterminate variety of plant being grown in a specific warm or cool climate. The structures offer limited resistance to tipping of not only the structure, but also the plant and fruit when subjected to a moderate wind.

U.S. Pat. No. 4,860,489 discloses an adjustable plant support. This structure also has limited resistance to tipping over in a moderate wind. U.S. Pat. Nos. 4,519,162 and 4,534,129 disclose an adjustable, vertical plant support structure. This structure depends on driving the vertical support into the ground, which may be limiting to some growers in certain regions.

### SUMMARY OF THE INVENTION

It is the intention of this invention to provide plant support assembly that allows the grower to adjust the plant supporting hoops on the vertical uprights according to the expected plant growth of any variety of plants. For example purposes, tomato plants will be described but this invention is in no way limited to use with only tomato plants. Tomato plants traditionally use some sort of support device in their growth since these plants grow rapidly and do not self support themselves when the weight of the plant and fruit becomes too much for the main plant to bear. An unsupported plant either bends and/or breaks under their own weight and the fruit becomes damaged by lying on the ground. One of the main advantages of the present invention is to prevent damage to both the plant and any fruits it may bear.

The market for this invention ranges from the casual gardener to the larger commercial produce growers. The invention is intended to be marketed in individual pieces to help control costs but a kit of like elements is well within the scope of invention. The kitting option would consist of selling a predetermined number of support hoops and upright support sections packaged as a set. The consumer could then purchase additional hoops and upright sections as required. This invention is intended to support any fruit or vegetable bearing plant and the added weight of the ripening fruit. This support device would prevent tipping of the plant and fruit when subjected to a moderate wind. The present invention is intended to save space by converting a sprawling plant into an upright growth pattern. Another advantage of this invention is to make maximum use of sunlight absorption by leaves and allows for easy access to clean fruit that is less subjected to disease, damage and ground dwelling creatures. The present invention also allows the support device to be easily disassembled and cleaned for winter storage.

### BRIEF DESCRIPTION OF THE DRAWINGS

FIG. 1 is a view showing the plant support assembly using hoops that are adjustable on vertical supports illustrating a preferred embodiment of the invention.

FIG. 2 is an enlarged view of the assembly for attachment of the hoop with the vertical support.

FIG. 3 is a front view of the inside of a rigid vertical support with holes or notches to accept a hoop.

FIG. 4 is a side view of the rigid vertical support of FIG. 3.

### DETAILED DESCRIPTION OF THE INVENTION

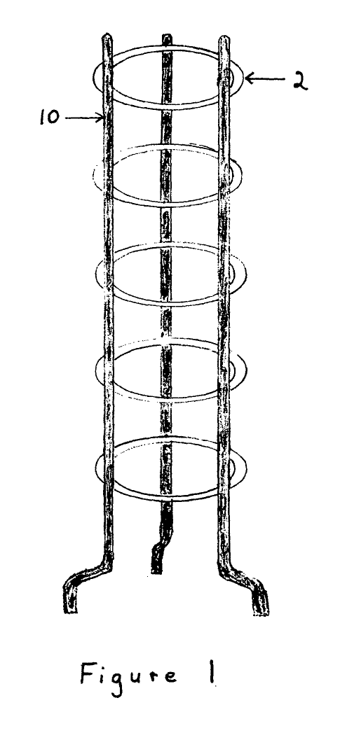

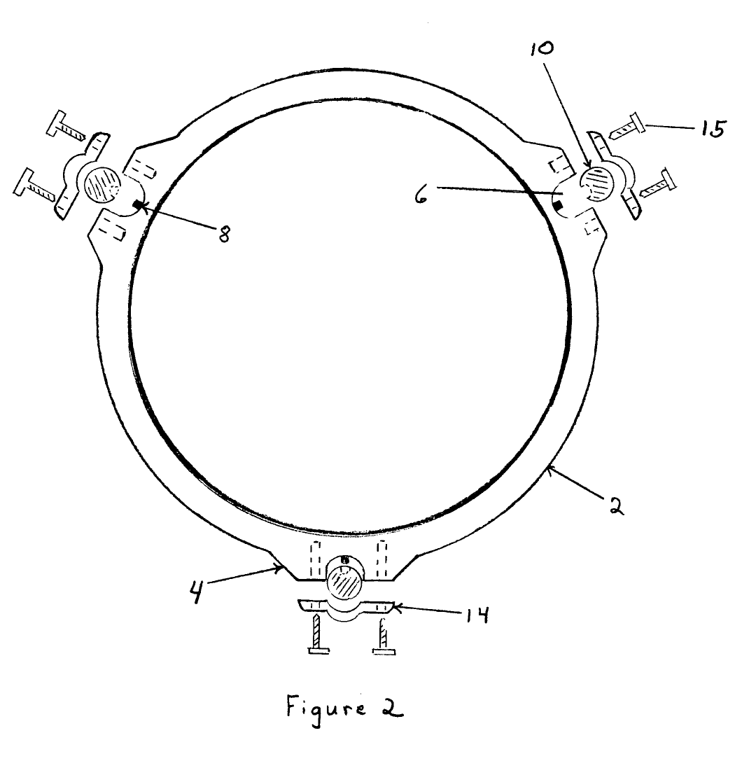

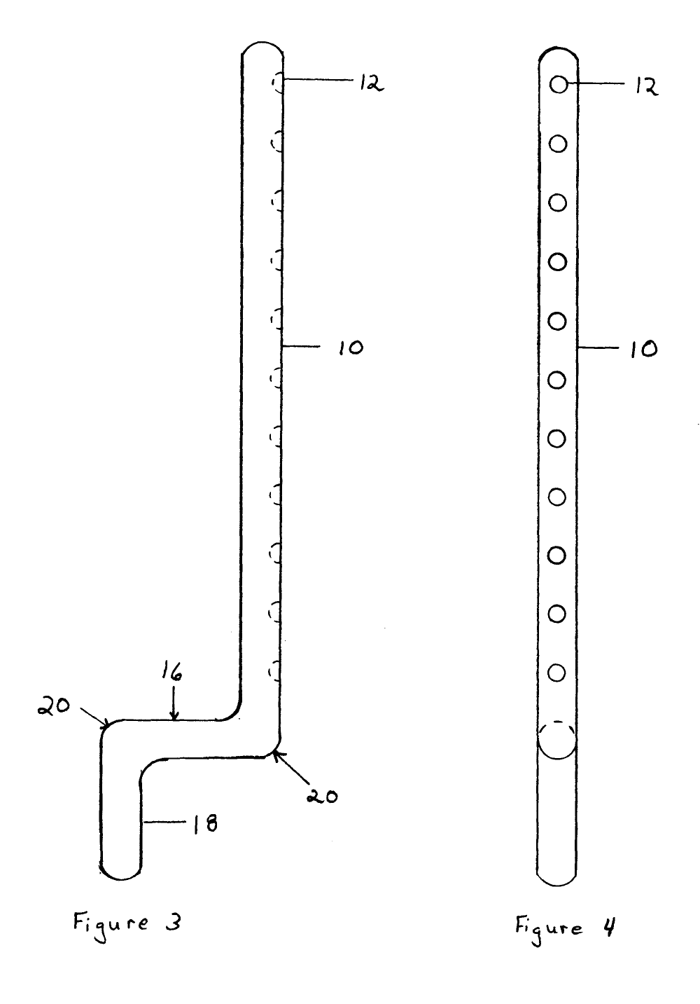

With reference now to the drawings, FIG. 1 shows the assembled support structure having a plurality of hoops (2) and upright sections (10). The uprights (10) can be of either solid or hollow construction. FIG. 2 shows a more detailed view of the hoop (2) and clamping mechanisms (4). The hoop (2) is shown as a circular member but any shape may be used. Three clamping mechanisms (4) are shown. More clamping mechanisms (4) should be used to provide enough strength if the shape of the hoop (2) is altered from the circular shape as shown. In use, the hoop (2) is positioned along uprights (10) at various heights that are determined by the user. The clamping mechanisms (4) then secure the hoops (2) to the uprights (10) via a set of securing hardware (15). The hoop (2) has a depression (6) and can have a knob (8) that forms one half of the clamping mechanism (4). A fitted piece (14) and screws (15) form the other half of the clamping mechanism (4). Each upright section (10) can have a plurality of holes (12) along its length. See FIGS. 3 and 4. These holes are sized to receive the knob (8) of the hoop (2) to lockingly engage the upright (10) to the hoop (2). When the fitted piece (14) is added, it is secured to the hoop (2) via tightening the securing screws (15). A clamping action takes place and secures the hoop (2) to the upright. The screws (15) are shown merely as a suitable securing mechanism but others such as clips, nuts, bolts, lags and the like are also well within the scope of acceptable alternatives. In general the number of clamping mechanisms (4) should correspond to the number of uprights (10). The lower parts of the uprights (10) have two degreed bends (20) to form a substantially horizontal portion (16) and a vertical portion (18). The bends are shown as 90 degree bends but it is understood that bend degrees may vary as long as the function of the device is not compromised. The lower portion of the uprights (10) is of a greater dimension than the upper portion of the uprights (10) thereby making the support device more stable when mounted to the ground. FIGS. 3 and 4 show this feature most clearly. It should be pointed out that although FIGS. 3 and 4 show that horizontal portion (16) and vertical portion (18) are of similar proportions, this is not essential to the function of the device. Best results are achieved when there is at least a 1:1 ratio of horizontal (16) to vertical (18). Horizontal member (16) should always be at least as long as vertical member (18).

In use, the plant support device is assembled by using the steps as discussed below. First the uprights (10) are assembled. The uprights may be of one piece or a plurality of pieces that must be assembled to make the maximum length as shown in FIG. 1. If the uprights (10) were assembled by interconnection of multiple pieces, an interconnection mechanism would be required. After the uprights are assembled, the hoops (2) are positioned along the length of the upright (10). If the version of the device which contains knobs and holes is used, the user engages the knob (8) into one of the series of holes (12) located along the length of the upright (10). It should also be noted that the hoops (2) may be of single piece construction or made of multiple pieces that would be interconnected to each other in a similar manner to how the upright pieces are connected together. An advantage to this construction would be to allow varying diameters and dimensions of the hoops (2) without having to purchase additional new hoops. Once the positioning and spacing of the hoops (2) is established, the fitted pieces (14) are added and secured by screws (15) to the hoop (2). This is now a complete assembly ready for use. The assembled support device is then positioned over the plant and secured to the ground by either embedding the vertical member (18) into the ground or by merely placing the support device on the ground. If the plant grows beyond the maximum height of the uprights, more upright sections (10) may be added to increase the height of the plant support device along with an appropriate number of hoops (2). Disassembly after the growing season is as easy as loosening the screws (15), removing the uprights (10) and cleaning the pieces prior to storage for the winter. Greenhouses that grow plants year round may never have to disassemble these units but the option is always available. The parts store compactly and conveniently in a garage, attic or even a closet until the next growing season.

While materials have not been discussed it should be known that any suitable materials such as plastics, resins, fiberglass, coated metals or the like may be used as long as they provide suitable strength for the purpose of the invention. Dimensions are not a critical portion of the invention but it should be clear that the size, shape and overall dimensions must be of substance to perform the function intended by the plant support device.

1. A plant support device for aiding in supporting climbing plants, said device comprising:
a plurality of uprights, each of said uprights having a profile, each of said uprights having two ends, one of said ends being a bent end having multiple bends to form a substantially horizontal portion and a vertical portion;
a plurality of hoops, each of said hoops having a plurality of clamping mechanisms for attaching said hoops to said plurality of uprights, said clamping mechanisms having a first part attached to said hoop and a second fitted part which is shaped to conform to the profile of said uprights, said clamping mechanisms further having securing means for attaching said second fitted part to said first part, whereby said hoops are removeably attached to said uprights forming a supporting structure for plants.

2. The plant support device of claim 1, wherein said uprights have a length and a plurality of holes along said length, said holes being arranged in a line along said length and spaced a predetermined distance apart.

3. The plant support device of claim 2, wherein said first part of said clamping mechanisms have a knob, said knob being sized and shaped to correspondingly engage said plurality of holes in said uprights to lockingly attach said hoops to said uprights when said securing means are tightened.

4. The plant support device of claim 1, wherein said securing means are hardware to attach said first part and said second fitted part together.

5. The plant support device of claim 1, wherein said one bent end is of greater dimension than the other end whereby the greater dimension provides a more stable base for attachment to the ground and prevents tipping of the support device and plant in a moderate wind.

6. The plant support device of claim 1, wherein said hoops are removeably attached to said uprights and can be separated by removing said securing means.

7. The plant support device of claim 1, wherein the number of said clamping mechanisms on each hoop corresponds to the number of uprights.

8. The plant support device of claim 1, wherein each of said uprights are of a set length and made of a single unitary construction, and each of said hoops are made of a single unitary construction.

9. The plant support device of claim 8, wherein said hoops are made in a plurality of geometric shapes and sizes to accommodate various size and shaped plants.

10. The plant support device of claim 1, wherein each of said uprights are made of several smaller individual pieces interconnected to form a maximum length; and each of said hoops is made of smaller portions interconnected to form various shapes and dimensions.

11. The plant support device of claim 1, wherein said uprights, hoops and clamping mechanisms are made of plastics.

12. The plant support device of claim 1, wherein said uprights, hoops and clamping mechanisms are made of metal.

13. The plant support device of claim 1, wherein said uprights, hoops and clamping mechanisms are made of fiberglass.

14. A plant support device for aiding in supporting climbing plants, said device comprising:
a plurality of uprights, each of said uprights having a profile, each of said uprights having two ends, one of said ends being a bent end having multiple bends to form a substantially horizontal portion and a vertical portion; each of said uprights having a length and a plurality of holes along said length, said holes being arranged in a line along said length and spaced a predetermined distance apart;
a plurality of hoops, each of said hoops having a plurality of clamping mechanisms for attaching said hoops to said plurality of uprights, said clamping mechanisms having a first part attached to said hoop and a second fitted part which is shaped to conform to the profile of said uprights, said first part of said clamping mechanisms further comprising a knob, said knob being sized and shaped to correspondingly engage said plurality of holes to lockingly attach said hoops to said uprights;
said second fitted part further having securing means for attaching said second fitted part to said first part, whereby said hoops are removeably attached to said uprights forming a supporting structure for plants; and
said one bent end being of greater dimension than the other end whereby the increased dimension provides a more stable base for attachment to the ground and prevents tipping of the support device and plant in a moderate wind.
